(19) United States
(12) Patent Application Publication
(10) Pub. No.: US 2019/0237059 A1
(43) Pub. Date: Aug. 1, 2019

(54) SYSTEM AND METHOD FOR CONTROLLING THE SOUND EMITTED BY AN UNMANNED AERIAL VEHICLE

(71) Applicant: Walmart Apollo, LLC, Bentonville, AR (US)

(72) Inventors: Robert CANTRELL, Herndon, VA (US); John J. O'BRIEN, Farmington, AR (US); Brian MCHALE, Oldham (GB); Phil STOUT, Bentonville, AR (US)

(73) Assignee: Walmart Apollo, LLC, Bentonville, AR (US)

(21) Appl. No.: 16/259,472

(22) Filed: Jan. 28, 2019

Related U.S. Application Data
(60) Provisional application No. 62/624,701, filed on Jan. 31, 2018.

(51) Int. Cl. G10K 11/178; B64C 39/02; G06F 16/909

(52) U.S. Cl. CPC G10K 11/17883; G10K 11/17823; B64C 2201/12; G06F 16/909; G10K 2210/1281; B64C 39/024

(57) ABSTRACT

Disclosed herein are systems and methods for controlling the noise and sound emitted by an unmanned aerial vehicle. The unmanned aerial vehicle may emit a sound to mask the noise created by the propellers of the vehicle. It may additionally emit sounds based on the information about the area surrounding the vehicle or the landing or delivery location of the vehicle.

### BACKGROUND

### 1. Technical Field

The present disclosure relates to unmanned aerial vehicles (UAVs) and more specifically to controlling the noise and sound emitted by a UAV.

2. Introduction

The use of UAVs for package delivery has become increasingly popular. UAVs have also been used to monitor traffic or deliver supplies to places that are not accessible by ground, for example, after a natural disaster. But deploying UAVs in areas populated by people and wildlife presents a number of challenges. For example, the rapid rotation of a UAV propeller emits a high-pitched noise that many people and animals find irritating or even alarming.

Considerable effort has been made in the UAV field to reduce the noise or mask the noise altogether. However, silent UAVs create unique problems. For example, if a person or animal is unaware that a UAV is approaching they may be startled. It may also create unwanted encounters with people or animals who would have otherwise avoided the UAV. In populated areas, people may be uncomfortable with UAVs—which may be equipped with cameras—silently flying overhead. This may be problematic particularly in UAVs used for package delivery because this will require UAVs to travel and deliver in residential areas. Customers may be discouraged from using UAV delivery services if it means consenting to a camera equipped device silently entering their private property without warning. Further, if the delivery is silent, the recipients lose the benefit of immediately being alerted to the UAVs arrival.

One solution is to design rotors, rotation speeds, noise masking technologies and/or noise generators so that the drone emits a pleasing sound, likely in the range of the sound of a car. This in principle, follows the idea that some engine sounds, such as the rumble of a luxury car, are actually quite pleasing to the ear. The current invention seeks to make a UAVs presence known without being annoying or otherwise undesirable.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the claims. These and other features of the disclosure will become more fully apparent from the following description and appended claims, or can be learned by the practice of the principles set forth herein.

In one embodiment, a system may comprise an unmanned aerial vehicle (UAV); a microphone for capturing the noise generated by an UAV and the sounds in the area surrounding the UAV (the ambient sound); a database for identifying the ambient sound captured by the microphone; and a sound generating device on the UAV for generating a masking sound identified by the database.

In another embodiment, a system may comprise an UAV having one or more propellers; a microphone for detecting the frequency of an audible wave produced by the one or more propellers; a processor for generating a destructive wave corresponding to the audible wave produced by the one or more propellers; and an audio playback device for emitting a sound from the UAV incorporating the destructive wave.

In other embodiments, a method may comprise capturing ambient sound in an area surrounding a UAV; determining based on the captured sounds information about the surrounding area; storing the information about the surrounding area on a database; and emitting a sound by a the UAV based on the information about the surrounding area.

### BRIEF DESCRIPTION OF THE DRAWINGS

FIG. 1 is a block diagram of a processing system embodiment;

FIG. 2 is a block diagram of an embodiment;

FIG. 3 illustrates an example method embodiment;

FIG. 4 illustrates an example method embodiment; and

FIG. 5 is a diagram of a noise masking embodiment.

### DETAILED DESCRIPTION

Disclosed are systems and methods for masking the noise emitted by an unmanned aerial vehicle (UAV) and generating a different, more pleasing sound. Various embodiments of the disclosure are described in detail below. While specific implementations are described, it should be understood that this is done for illustration purposes only. Other components and configurations may be used without parting from the spirit and scope of the disclosure. While the embodiments identified herein are directed at a UAV, the principles may be applied to any vehicle, such as a car or plane. In some embodiments the generated sound may be trademarked or have a positive trademark effect to remind the public of the retailer. For example, the generated sound may be a distinctive jingle associated with a retailer or product that is played when the UAV is arriving. In other embodiments, the sound generated may simply be intended to blend in with the background, like a car driving down the street.

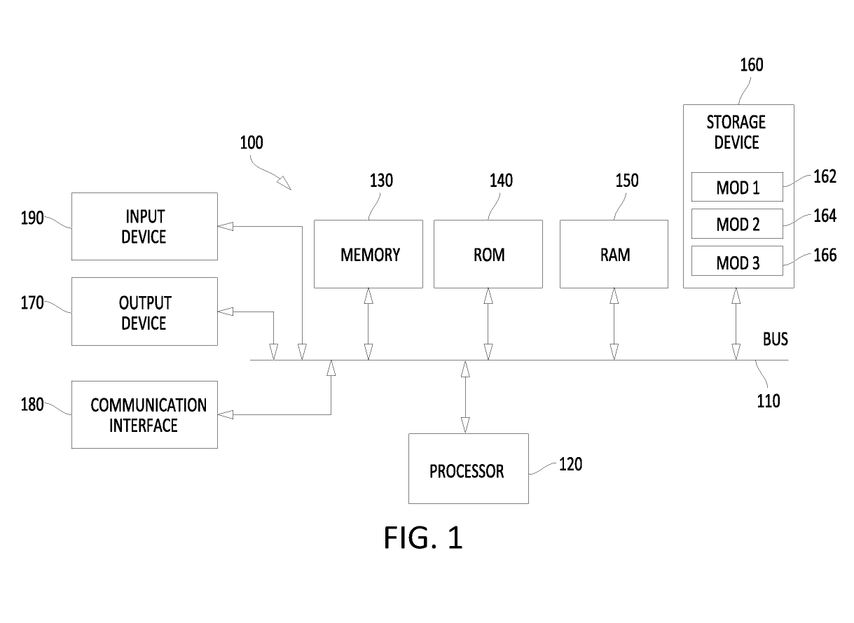

With reference to FIG. 1, an exemplary system includes a general-purpose computing device 100, including a processing unit (CPU or processor) 120 and a system bus 110 that couples various system components including the system memory 130 such as read-only memory (ROM) 140 and random access memory (RAM) 150 to the processor 120. The system 100 can include a cache of high-speed memory connected directly with, in close proximity to, or integrated as part of the processor 120. The system 100 copies data from the memory 130 and/or the storage device 160 to the cache for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer-readable storage media provide nonvolatile storage of computer-readable instructions, data structures, program modules and other data for the computing device 100. In one aspect, a hardware module that performs a particular function includes the software component stored in a tangible computer-readable storage medium in connection with the necessary hardware components, such as the processor 120, bus 110, display 170, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 100 is a small, handheld computing device, a desktop computer, or a computer server.

Although the exemplary embodiment described herein employs the hard disk 160, other types of computer-readable media which can store data that are accessible by a computer, such as magnetic cassettes, flash memory cards, digital versatile disks, cartridges, random access memories (RAMs) 150, and read-only memory (ROM) 140, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

The UAV may have a control unit for controlling the emitted noise and the generated sound emitted by the UAV. The control unit may control the sounds generated by an audio playback device, such as a speaker, for emitting audio from the UAV. The control unit may also control the operation of the UAV, such as the altitude of the UAV or speed of rotation or activation of the propellers so as to adjust the noise made by the UAV as perceived by people, pets, and wildlife. The UAV may also include sensors, such as a camera or a microphone for detecting the surroundings of the UAV. Information about the UAVs operating conditions, information received from a database, or output from the UAV sensors may be received and evaluated by a processor coupled to a control unit. The processor may be located at the UAV or remotely. The UAV may also send and receive information from a processor or sensor to a database. The UAV may transmit or receive information about the surroundings of the UAV or specific events or persons near the UAV or its path of transit.

Still further embodiments may generate a sound to alert wildlife or pets that the UAV is nearby. This may be used as an alert to birds in the air to avoid collision. It may also be used to deter animals from approaching the UAV as it nears the ground for a delivery or landing. This may have the additional effect of deterring animals from approaching a package that has been delivered.

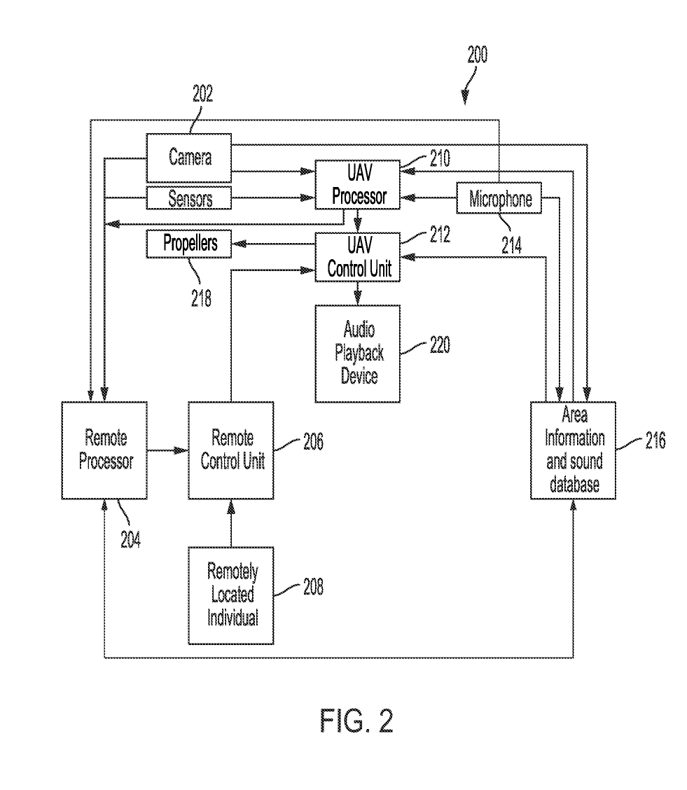

FIG. 2 is a block diagram of an example embodiment 200. System 200 may have a camera or other sensors 202 communicatively coupled to a UAV processor 210 located on or in the UAV. Processor 210 or the UAV be may additionally be communicatively coupled to a remotely located processor 204. The system 200 may also include a microphone 214 coupled to processor 210 for capturing ambient sound and/or the sound produced by the UAV (UAV sound), the microphone 214 may also be coupled to an area-information and sound database 216. The remote processor 204 may receive sound information from the UAV processor 210, the database 216, and/or the microphone 214. In some embodiments the remote processor may identify the sound captured by the microphone and may determine the appropriate playback sound. In other embodiments this determination may be made by a remotely located individual 208 that may be monitoring the UAV. In still further embodiments, a remotely located processor may use input from the camera or sensors 202 when making this determination. In further embodiments, the processor may use sound stored in the database to identify the sound by comparing the captured sound with sound files stored in database 216. The appropriate playback sound may be stored in the database in some embodiments, the processor may access the stored sound based on the sound captured by the microphone or other operating factors, such as the altitude of the UAV or the geographic location of the UAV. The processor may also use external factors, such as the time of day or the activity in the area when determining the appropriate playback sound. This determination may also occur at the UAV processor instead or in combination with the remotely located processor. Remote processor 204 may be communicatively couple to remote control unit 206 which may additionally receive information or instructions from a remotely located individual 208 that may monitor the feed from camera and sensors 202 or the microphone 214 or other operating conditions of the UAV. In some embodiments, the remotely located individual 208 may navigate the UAV or monitor its geographic location. The remote control unit 206 may receive operating commands from the remote processor 204 and/or the remotely located individual 208. Remote control unit 206 may then transmit these commands to UAV control unit 212. UAV control unit 212 may then control various operating conditions of the UAV, for example, the operation of the propellers 218 or the sound emitted from the audio playback device 220. Audio playback device 220 may be a speaker.

In still further embodiments, the sound generated while the UAV is in transit may be designed to blend into the background, or ambient sound, or alert airborne animals to its presence and the sound may change when the UAV is near the ground, for example, when the UAV is making a delivery. If the UAV is landing or making a delivery, the emitted sound may be used to alert the intended recipient that the UAV has arrived. For example, if a UAV delivers a package, the UAV may play a jingle associated with the product or retailer upon delivery. In still further embodiments, the UAV may announce the intended recipient of the UAV's package or the contents it may be delivering, by playing the name of the intended recipient or emitting another recipient-identifying sound upon delivery. In some embodiments the processor may determine whether the UAV is making a delivery my monitoring the altitude of the UAV. When the UAV falls below a threshold altitude the processor may determine that a delivery is being made and initiate playback of a masking sound. When the UAV is above a threshold altitude, the system may lower the volume or eliminate the playback of the masking sound. In still further embodiments, the processor may determine that the UAV is making a delivery by monitoring the geographic location of the UAV. It may then compare the geographic location to the location of intended delivery, when the distance between the UAV and the location of delivery is below a threshold, the processor may determine that a delivery is being made and initiate feedback of a masking sound.

In still further embodiments, a sound may be emitted only when the UAV is within earshot of the ground, for example, when it is below a certain altitude. It may also determine whether noise masking is necessary based on the noise level of its surroundings. For example, in a noisy area the otherwise undesired sound emitted by the operation of the UAV may not be audible or distinguishable. The UAV may also be responsive its surroundings, and emit a sound based on information from a database or received by a sensor, microphone, or camera located on the UAV. A sensor, microphone, or camera may also transmit data to a database for analysis and/or storage.

In still further embodiments, the rotor and/or propeller may be operated at a lower speed and emit a lower frequency sound when the UAV is below a certain altitude or determined to be taking-off or landing.

In one embodiment, UAV control unit may control the operation of the rotor, engine, or propeller to mask or minimize the noise emitted by the UAV. For example, the processor may determine that the noise may be masked by activating an additional propeller that is 180 degrees out of phase with the first propeller. This may be used to minimize the audible noise.

In other embodiments, a sound may be played by an audio playback device, the sound may include an audible wave that is out of phase with the noise of the propeller, thus minimizing or lessening the level of audible sound. In some embodiments, the secondary canceling wave may be the sum of multiple wave functions, the first function may be the 180 degree out-of-phase wave for cancelling the sound created by the UAV and the second function may be the desired sounds so the combination of the two waves will cause only desired sounds to be audible. In some embodiments, the out-of-phase sound may only be initiated when the UAV is within hearing range. For example, when the UAV is below a certain altitude that is determined to be audible to persons on the ground. In some embodiments, another sound that may be audible to birds or other wildlife may also be generated by the audio playback device. In some embodiments, the additional sound may be generated only when the noise masking measures are being taken, for example, when the UAV is below a given altitude. In other embodiments, the sound and noise control measures will only be employed if a processer first determines that there are people or animals in the area.

For example, a UAV operating at an altitude determined to be outside of hearing range may not employ any noise masking or cancellation measures. When the UAV approaches its destination it may lower in altitude and activate its noise masking measures. In some embodiments a sensor on the UAV may be used to determine if there are people, pets, or wildlife in the landing or delivery area. For example, if the UAV determines that there are no people in the area but there is a dog, the UAV may emit a noise intended to deter dogs that may not be audible to humans. The processor may then communicate to the database that there is a dog at that location so that future UAVs in the area can respond accordingly. If a person is detected by the sensor, the UAV may emit a noise masking sound to minimize the undesired sound produced by the propeller, engine, or rotor and may additionally emit a more pleasing sound.

In other embodiments a masking sound may be emitted only while the UAV is in flight to a destination. And a deterrent sound may be emitted in places where there is a likelihood of wildlife interactions. The appropriate masking sound or measures may be determined based on information from sensors on the UAV or from information transmitted by a database containing information about the UAV location. The UAV may also transmit information from sensors detecting people, pets, or wildlife (or lack thereof) to a database.

The database may be coupled to a number of UAVs or other sensors and other databases storing location and sound information. The database may store information about the wildlife in the area, domestic animals in the area, the population of the area, the traffic in the area, or other relevant information. For example, the database may store information about a neighborhood, such as the language spoken in the neighborhood. Therefore, if a UAV generates an audio message, the message may be in the language that is used in the neighborhood. The stored information may also be specific to a particular house or person. The database may also store or access information about the amount of traffic in the area, for example, if the area does not have significant traffic, the processor may instruct the UAV to play nature sounds to mask the noise of the UAV. In another example, the database may indicate that there are a number of rodents in the area where a UAV is making a delivery. The processor may instruct the control unit to emit a deterring sound, such as a high pitch alarm, to deter wildlife from approaching the UAV or the package. For example, the UAV may emit a sound that is at a frequency that cannot be perceived by humans but may deter other animals. In other embodiments, the UAV may emit sounds at a frequency that deters wildlife while also emitting a tune or jingle to alert the intended recipient of its arrival. The UAV may also detect a number of wildlife in an area and transmit the information to the database for use by other UAVs that may be in that area.

In some embodiments, a microphone may be used to record or identify the sounds in the area surrounding the UAV. The UAV may emit these same sounds, which may be processed or amplified, back to mask the sound of the UAV. In other embodiments, the sounds detected by the microphone may be evaluated and similar or complementary sounds, that may be stored in the UAV or a database, may be emitted by the UAV.

Further, the UAV may transmit information from its sensors to the database. The database may continually update based on information received by the sensors of the UAVs. For example, a microphone may capture the sound of children playing. A processor may then analyze and identify the sound. The database may then store the sound in the database and information that the area may contain children. It may further store that a park or school may be in the area. The database may also store information received from other sensors on the UAV, such as a camera. Thus, if a future UAV is in the area, the database may transmit this information so the UAV can respond accordingly. In some embodiments the UAV may play back the captured sound if it detects that it is in the area identified in the database as corresponding to the sound so that it may blend into the background.

The database may also store information about a date or activities in the area. For example, a processor may determine that there is a football game near a delivery area. The database may instruct the UAV to play the song of the team playing. In another example, the processor may determine that it is December 25^{th}, and the database may instruct the UAV to play a Christmas song.

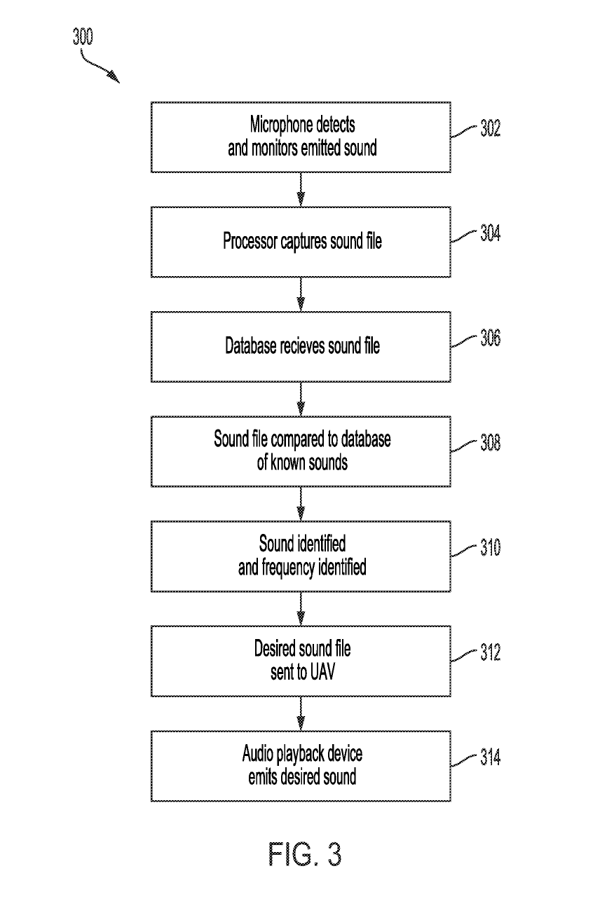

FIG. 3 depicts a method 300 for operating a sound masking system. At 302 a microphone or other sound sensor detects and monitors the noise emitted from the UAV and the sounds of the surrounding area or ambient sound. The noise may be caused by the movement of the rotor, engine, or propeller. The noise and sound may be captured by a microphone or other sensors at 304 and the captured sound file or sound feed may be transmitted to the database and received at 306. The captured sound may include that which is created by the UAV and may also include sounds captured by the microphone that are emitted from other sources, such as traffic. The noise of the UAV and the sounds of the surrounding area may be transmitted to a processor, which may be remotely located. The UAV may be coupled to the remote database by wireless internet or Bluetooth. At 308, the noise and sound may be compared to other stored sounds in the database. The sounds in the database may be of known origin, for example, the database may store a sound file identified as traffic. At 310, the sound may be identified, the identification may be based on the similarity of the sound and a known sound in the database, and the frequency of the noise may be identified. The identified frequency may be used to control the frequency of the masking sounds emitted by the UAV. It may also be used to determine what emitted sounds may best compliment the noise of the UAV and its surroundings to minimize annoyance or provide the desired deterrent or an indication that the UAV or package has arrived. In some embodiments, the known sound corresponding to the ambient sound detected may also correspond to a stored masking sound. A masking sound may be located or created and sent to the UAV at 312. At 314 the masking sound may be emitted by the audio playback device.

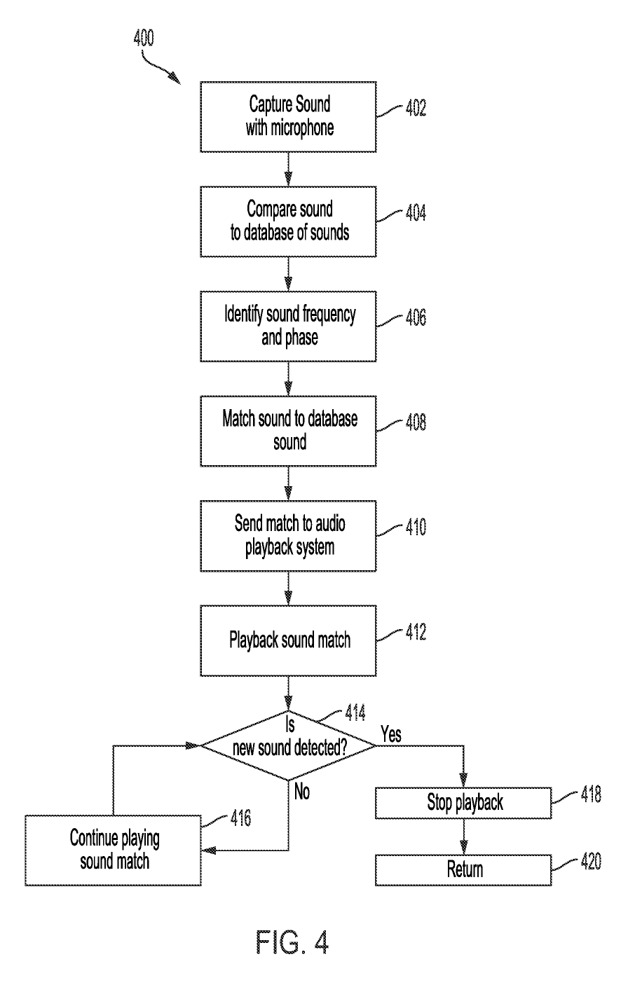

FIG. 4 depicts a method 400 for operating a sound masking system. At 402, the UAV may capture the sounds surrounding the UAV or emitted by the UAV. In one embodiment, the processor may filter the noise emitted by the UAV from the sound captured by the microphone in order to isolate the sounds in the airspace surrounding the UAV. In other embodiments the processor may filter out the background noise and isolate only the sound being generated by the UAV. At 404 the captured sound from the UAV's surroundings may be sent to a database of identified sounds and frequencies. At 406 the captured sound may be evaluated and a matching, corresponding, or complementary sound may be identified in the database of sounds at 408. For example, the captured sound may be compared to the identified sounds in the database using any of the sound comparison techniques known in the art. If the captured sound is found to be sufficiently similar to traffic, the captured sound may be identified as traffic and matched to the sound of traffic in the database. In further embodiments, the sound of traffic may be identified and a corresponding known sound, such as that of a single car engine, may be identified in the database as corresponding to the captured sound. In another example, the sound may be matched to a cheering crowd and the fight song for the school at that location may be identified in the database as a corresponding sound. In still further embodiments, the captured sound may be created by the spinning propellers or rotors. This sound may be evaluated and a complementary sound having the same or a complimentary frequency but a different phase may be located in the database.

At 410, the matched, complimentary, and or corresponding sound is transmitted to the UAV. In other embodiments, the database may send information that identifies a sound stored locally in the UAV memory. At 412, the UAV may play the matched sound in an audio playback system, such as a speaker, located on the UAV. The UAV may continue to monitor the sound captured by the microphone. If a new sound is detected at 414 the method may stop the audio playback of the matching sound at 418 and the method may repeat at 420. If no change or a negligible change in the sound is detected the method may continue playing the matched sound at 416 and continue monitoring for a change in the detected sound. For example, a UAV flying over a roadway may submit the sound to the database which may then identify the sound of traffic, the database may then identify traffic sounds stored in the database and send a traffic sound for playback by the UAV. If the UAV then flies over a beach, the UAV may send a new sound to the database for identification, the database may then send the sound of waves crashing to the UAV which may then be emitted by the UAV.

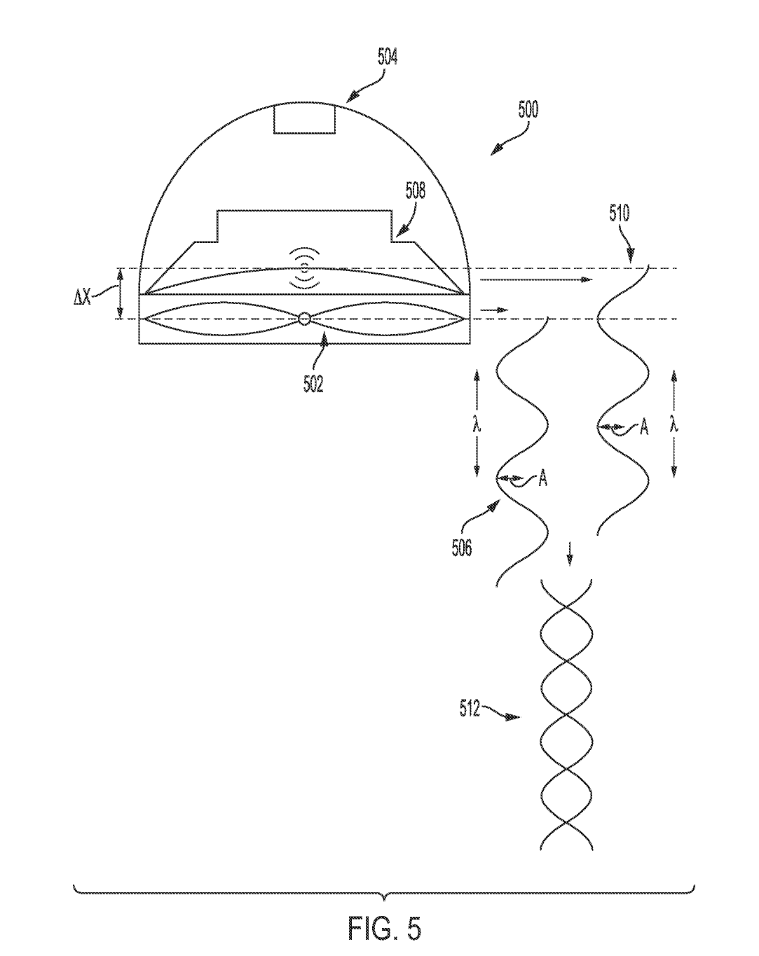

FIG. 5 is a diagram of an embodiment of a sound masking system 500 wherein the noise of a UAV may be masked or minimized using destructive wave interference. As shown in FIG. 5, the undesirable soundwave 506 may be emitted by the agitation of the air by the rotation of propellers 502. The undesirable soundwave may have amplitude A. The emitted sound may be captured by microphone or sensor 504. A processor may detect the frequency of the sound captured. The processor may be communicatively coupled to an audio playback device such as speaker 508. Speaker 508 may be positioned a known distance, ΔX, away from propellers 502. In some embodiments the audio playback device may be a known distance or multiple known distances from multiple propellers. The processor may cause the speaker 508 to vibrate such that destructive soundwave 510 is produced. Destructive soundwave 510 may be emitted so that it is 180 degrees out of phase with undesirable soundwave 506. The phase of destructive soundwave 510 may be determined, in part, by known distance ΔX. The undesirable soundwave 506 and destructive soundwave 510 may cancel forming audible soundwave 512. The audible soundwave may also be combined with a desired sound that may have been received by the processor from a database. System 500 may also operate consistent with other sound masking or cancellation methods known in the art.

In other embodiments, the noise of the UAV may be captured and transmitted to a processor to determine the frequency of the sound created by an engine, a rotor, and/or propellers. In other embodiments the frequency may be assumed by or calculated from the speed of the rotor or propellers. The frequency and phase of the emitted audible wave may be determined by a processor at the UAV or located remotely, such as in a database. The UAV may then be instructed to emit a destructive wave with the same frequency as the noise output by the rotor and propeller, but 180 degrees out of phase. The destructive wave may be the same amplitude as the original wave for maximum destruction or less that the original wave's amplitude to lower the perceived volume. In some embodiments the destructive wave may be created physically, for example, the UAV may operate a rotor or propeller in such a way as to create destructive waves. In still further embodiments, the air agitated by the rotor or propeller may be directed towards a hollow device that may tune the wave. In still further embodiments, an audio sound may be played that counters the emitted wave to the extent that it produces a more pleasant or distinctive sound.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A system comprising:
an unmanned aerial vehicle (UAV) comprising:
a microphone that captures an ambient sound and a UAV sound;
a sensor that monitors an operating condition of the UAV;
a database communicatively coupled to the UAV that stores a plurality of known sounds;
a processor communicatively coupled to the database and the UAV wherein the processor receives the UAV sound, the ambient sound, and the operating condition, compares the ambient sound to the plurality of known sounds, identifies a corresponding known sound within the known sounds, and identifies a masking sound corresponding with the known sound; and
a sound generating device coupled to the UAV that emits the masking sound received from the processor.

2. The system of claim 1, wherein the sound generating device includes an audio playback device.

3. The system of claim 1, wherein the sound generating device includes propellers.

4. The system of claim 1, wherein the database stores information about geographic locations and the processor uses a geographic location of the UAV to identify the masking sound.

5. The system of claim 1, wherein the corresponding known sound is determined based on its similarity to the ambient sound.

6. The system of claim 1, wherein the sensor is an altitude sensor, a geographic location sensor, an RPM sensor, a speed sensor, or a camera.

7. The system of claim 1, wherein the masking sound is determined based on a calendar date.

8. A method comprising:
capturing an ambient sound around a UAV;
comparing the ambient sound to a plurality of known sounds in a database;
determining a known sound in the database of known sounds based on a similarity between the ambient sound and the known sound;
identifying a source of the ambient sound based on information stored in the database corresponding to the known sound;
storing the source of the ambient sound in the database;
identifying a masking sound corresponding to the known sound;
transmitting the masking sound to the UAV; and
emitting the masking sound from the UAV.

9. The method of claim 8, wherein the information stored in the database indicates whether an animal or animals are near.

10. The method of claim 8, wherein the information includes a noise level in the area.

11. The method of claim 8, wherein the masking sound is determined based a geographic location of the UAV.

12. The method of claim 8, wherein an altitude of the UAV is determined, the altitude is compared to an altitude threshold, and the masking sound is determined based on the altitude being below the altitude threshold.

13. The method of claim 12, wherein a volume of the masking sound decreases when the altitude is above the altitude threshold.

14. The method of claim 8, wherein a geographic location of the UAV is determined, a distance between the geographic location and an intended destination is calculated, and the masking sound is determined based on the distance being less than a threshold distance.

15. The method of claim 14, wherein a volume of the masking sound decreases when the distance is more than a threshold distance.

16. A system comprising:
a UAV having one or more propellers;
a sensor coupled to the UAV that captures an audible wave produced by the one or more propellers;
a processor communicatively coupled to the sensor that receives the audible wave, detects a frequency of the audible wave, generates a destructive wave corresponding to the audible wave, and creates a desired sound by combining the destructive wave with a stored sound;
a control unit coupled to the UAV and communicatively coupled to the processor; and
an audio playback device coupled to the control unit that receives the desired sound from the control unit and emits the desired sound.

17. The system of claim 16, wherein the stored sound is generated from an ambient sound captured by the sensor.

18. The system of claim 16, wherein the sensor is a microphone.

19. The system of claim 16, wherein the stored sound is housed on a database and determined based on an ambient sound detected by a microphone.

20. The system of claim 16, wherein the stored sound is determined based on a geographic location of the UAV.
